(19) United States
(12) Patent Application Publication
(10) Pub. No.: US 2009/0195014 A1
(43) Pub. Date: Aug. 6, 2009

(54) Vehicle mosquito net

(76) Inventor: Karen Gathman, Sheridan, CO (US)

Correspondence Address: BARBER LEGAL, P.O. BOX 16220, GOLDEN, CO, 80402-6004, US

(21) Appl. No.: 12/069,014

(22) Filed: Feb. 6, 2008

(51) Int. Cl. B60R 21/02

(52) U.S. Cl. 296/152

(57) ABSTRACT

The present invention teaches a vehicle window mosquito net having an excess of fabric beyond the dimension of the vehicle window so that the excess fabric may be draped over the vehicle door and the door closed to secure up to three sides of the invention in place. The present invention further teaches use of flexible polymer tubing on at least one edge, such as the bottom edge, the flexible polymer tubing dimensioned and configured to fit into the window channel at the bottom of a typical vehicle window. The present invention yet further teaches that mosquito netting for vehicles may advantageously be held in place by hook-and-loop fabric engaging the vehicle's fabric interior, may come equipped with small devices such as pockets, pouches and ties which allow easy storage when not in use and may be coated with a pyrethroid insecticide.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to mosquito net devices, and specifically to vehicle mosquito net devices.

### STATEMENT REGARDING FEDERALLY FUNDED RESEARCH

This invention was not made under contract with an agency of the US Government, nor by any agency of the US Government.

### BACKGROUND OF THE INVENTION

Cooling of vehicles either requires rolling down a vehicle window or running the vehicle engine to power the vehicle air conditioning.

Airborne pests such as mosquitoes can ruin such quiet times if the window is to be rolled down. On the other hand, if the vehicle air conditioner is to function, the engine must run, which makes noise. If the engine is stopped and the windows rolled down, the mosquitoes, gnats, flies, hornets and all the other similar nuisances can enter.

The problem of airborne pests is exacerbated by the modern prevalence of diseases which are spread by airborne insects. West Nile Virus, a disease unknown in the New World just eight years prior to this application, is now found in 48 states. Dengue Fever, Yellow Fever, Malaria and other diseases may be found all over the world. The present invention suggests method of saving lives and reducing the prevalence of pandemics.

In addition to this, the dramatic increase in the cost of motor vehicle fuels means that more and more people are returning to rolling down their windows.

For all of these reasons and others, quality of life, safety, fuel economy and convenience may be enhanced by use of an improved device to keep insects from vehicle interiors.

Searching in the patent office database reveals several items, mostly dating from the times before the popularization of vehicle air conditioning.

U.S. Pat. No. 55473, issued Jun. 12, 1866 to J. G. De Coursey, teaches a home mosquito net having elasticized edges. The size is clearly depicted to be appropriate to a household window rather than a vehicular rear hatch.

U.S. Pat. No. 1,744,177, issued Jan. 21, 1930 to H. M. Schuler teaches a mosquito net more or less permanently attached to automobile.

U.S. Pat. No. 2,595,833 issued May 6, 1952 to J. T. Flaherty teaches an actual vehicular mosquito net having magnets around the margins to retain it in place in/on an automobile. However, in 1952 the interior and exterior of an automobile largely consisted of ferrous metals suitable for magnetic siting. Modern vehicles tend to have plastic and fabric interiors and even fiberglass bodies on occasion.

U.S. Pat. No. 2,665,754 issued Jan. 12, 1954 to R. H. Claussan et al teaches an automobile window screen having an elastic and draw-string edge.

U.S. Pat. No. 2,711,7036 issued Sep. 6, 1955 to E. F. Harris teaches an automobile window mosquito net having an elastic drawstring.

U.S. Pat. No. 4,249,589 issued Feb. 10, 1981 to Loeb teaches a netting with hook-and-loop fabric but dimensioned and configured structurally for residential usage.

U.S. Pat. No. 5,290,086 issued Mar. 1, 1994 to Tucker teaches a rear-window net for racing vehicles, which seems to be semi-permanent, as such vehicles encounter large amounts of fairly dangerous flying debris during races and the like.

U.S. Pat. No. 5,984,405 to Ciacci on Nov. 16, 1999 teaches an exterior netting panel for vehicle roof openings. It is structured for external usage. U.S. Pat. No. 4,139,233 issued Feb. 13, 1979 to Bott teaches another item of little interest, as does U.S. Pat. No. 6,983,970 issued Jan. 10, 2006 to Bateman.

It would be preferable to provide a device allowing a simpler and quicker installation and removal procedure, not using magnets and having a higher efficacy against mosquitoes and similar flying pests.

### SUMMARY OF THE INVENTION

The present invention teaches a vehicle window mosquito net having an excess of fabric beyond the dimension of the vehicle window so that the excess fabric may be draped over the vehicle door and the door closed to secure up to three sides of the invention in place. The present invention further teaches use of flexible polymer tubing on at least one edge, such as the bottom edge, the flexible polymer tubing dimensioned and configured to fit into the window channel at the bottom of a typical vehicle window. The present invention yet further teaches that mosquito netting for vehicles may advantageously be held in place by hook-and-loop fabric engaging the vehicle's fabric interior. The present invention yet further teaches that the netting may come equipped with small devices such as pockets, pouches and ties which allow easy storage when not in use. The present invention yet further teaches that the netting may be coated with a pyrethroid insecticide such as pyrethrin.

### SUMMARY IN REFERENCE TO CLAIMS

It is therefore another aspect, advantage, objective and embodiment of the invention, in addition to those discussed previously, to provide a vehicle accessory comprising:
a mosquito net dimensioned and configured to cover a vehicle window and having at least one edge;
a first flexible polymer tube secured to the at least one edge.

It is therefore another aspect, advantage, objective and embodiment of the invention to provide a vehicle accessory, further comprising:
a second flexible polymer tube secured to the at least one edge.

It is therefore another aspect, advantage, objective and embodiment of the invention to provide a vehicle accessory, wherein the first flexible polymer tube further comprises:
a deformable plastic.

It is therefore another aspect, advantage, objective and embodiment of the invention to provide a vehicle accessory, further comprising:
a pocket attached to the vehicle accessory, the pocket dimensioned and configured to accept the mosquito net and first flexible polymer tube when the mosquito net and first flexible polymer tube are disposed in a folded position.

It is therefore another aspect, advantage, objective and embodiment of the invention to provide a vehicle accessory, further comprising:
at least one tie attached to the vehicle accessory, the tie long enough to encompass the mosquito net and first flexible polymer tube when the mosquito net and first flexible polymer tube are disposed in a folded position.

It is therefore another aspect, advantage, objective and embodiment of the invention to provide a vehicle accessory, further comprising:
a coating of pyrethroid insecticide.

It is therefore another aspect, advantage, objective and embodiment of the invention to provide a vehicle accessory, comprising:
a mosquito net dimensioned and configured to cover a vehicle window and having at least one edge;
a first hook-and-loop fabric panel secured to the at least one edge.

It is therefore another aspect, advantage, objective and embodiment of the invention to provide a vehicle accessory, further comprising:
a second hook-and-loop fabric panel secured to the at least one edge at a location distal the first hook-and-loop fabric panel.

It is therefore another aspect, advantage, objective and embodiment of the invention to provide a vehicle accessory, further comprising:
at least one tie attached the vehicle accessory, the tie long enough to encompass the mosquito net and first flexible polymer tube when the mosquito net and first flexible polymer tube are disposed in a folded position.

It is therefore another aspect, advantage, objective and embodiment of the invention to provide a vehicle accessory, further comprising:
a coating of pyrethroid insecticide.

It is therefore another aspect, advantage, objective and embodiment of the invention to provide a vehicle accessory, further comprising:
a pocket attached to the vehicle accessory, the pocket dimensioned and configured to accept the mosquito net and first flexible polymer tube when the mosquito net and first flexible polymer tube are disposed in a folded position.

It is therefore another aspect, advantage, objective and embodiment of the invention to provide a vehicle accessory, comprising:
a mosquito net dimensioned and configured to cover a vehicle rear hatch perimeter and having at least one edge;
an elastic member having a length, the length sufficient to allow the elastic member, when distended, to pass around the vehicle rear hatch perimeter.

It is therefore another aspect, advantage, objective and embodiment of the invention to provide a vehicle accessory, wherein the elastic member is further firmly secured to the at least one edge of the mosquito net.

### BRIEF DESCRIPTION OF THE DRAWINGS

FIG. 1 is a planform side view of a first embodiment of the invention having “weather stripping” type flexible polymer tubing across the bottom edge.

FIG. 2 is a planform side view of a second embodiment of the invention having “crunch tube” type deformable plastic tubing across the bottom edge.

FIG. 3 is a planform side view of a third embodiment of the invention having hook-and-loop fabric fasteners disposed about the periphery.

FIG. 4 is a planform side view of a fourth embodiment of the invention having a series of shorter flexible or crunch style polymer/plastic tubes across the bottom edge.

FIG. 5 is a planform side view of a fifth embodiment of the invention having a built-in pocket for containerizing the device when not in use.

FIG. 6 is a rear planform view of a sixth embodiment of the invention having an elastic peripheral member and a larger size suitable for hatchback applications.

FIG. 7 is a side planform view of an embodiment of the invention in use draped over the outside of a vehicle door.

FIG. 8 is a side planform view of a seventh embodiment of the invention having ties used to secure the device when rolled/folded.

FIG. 9a is a view of one side of a pouch of an eighth embodiment, the pouch used for holding the invention when not in use.

FIG. 9b is a view of one side of a pouch for holding the eighth embodiment of the invention when not in use.

FIG. 10 is a side planform view of an embodiment of the invention in use draped over the inside of a vehicle door.

### INDEX TO REFERENCE NUMERALS

Mosquito net 102
First side 104
Second side 106
Third side 108
Bottom side 110
Polymer tubing 112
Mosquito net 202
First side 204
Second side 206
Third side 208
Bottom side 210
Plastic tubing 212
Mosquito net 302
First side 304
Second side 306
Third side 308
Bottom side 310
Hook-and-loop fabric 320
Hook-and-loop fabric 322
Tubing sections 412a,412b,412c,412d,412e
Pocket 530
Flap 532
Hook-and-fabric 534
Vehicle rear end 602
Hatch 604
Hatchway edge 606
Mosquito net 608
Elastic 610
Mosquito net 702
Front edge 704
Rear edge 706
Top edge 708
Bottom edge 710
Vehicle 750
Vehicle door 752
Window edge/channel/track 754
First tie 860
Second tie 862
First side of pouch 970
Second side of pouch 972
Closure flap 974
Hook-and-loop fabric 976
Hook-and-loop fabric 978a, 978b, 978c
Mosquito net 1002
Hanging excess 1004
Vehicle 1050
Vehicle door 1052

### DETAILED DESCRIPTION

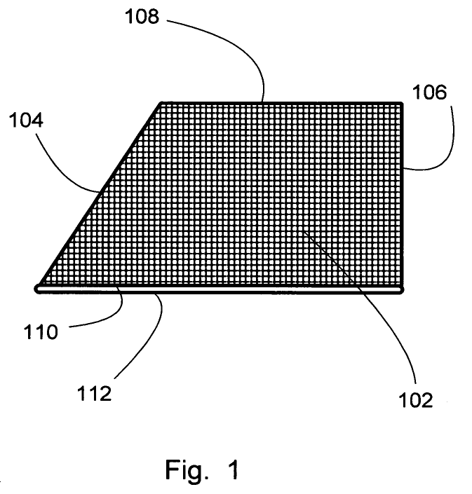

FIG. 1 is a planform side view of a first embodiment of the invention having “weather stripping” type flexible polymer tubing across the bottom edge. Mosquito net 102 may have first side 104, second side 106, third side 108 and a fourth bottom side 110. These sides may be dimensioned and configured to approximately match the shape of a typical vehicle window, and to exceed the dimensions of the typical window. In the presently preferred embodiment and best mode presently contemplated for carrying out the invention, a long lasting type of flexible polymer tubing is used.

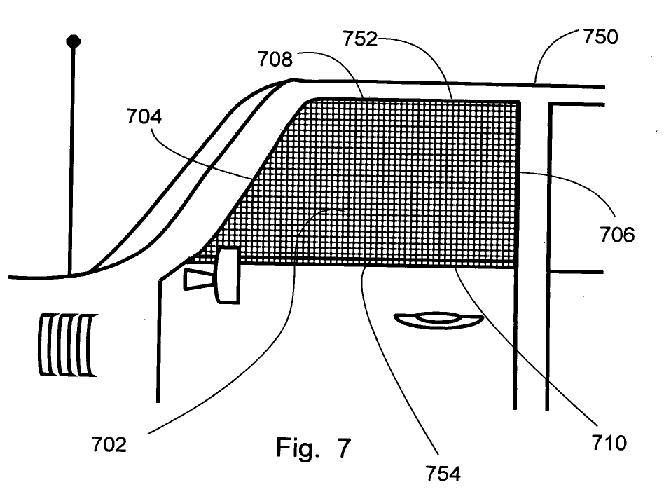

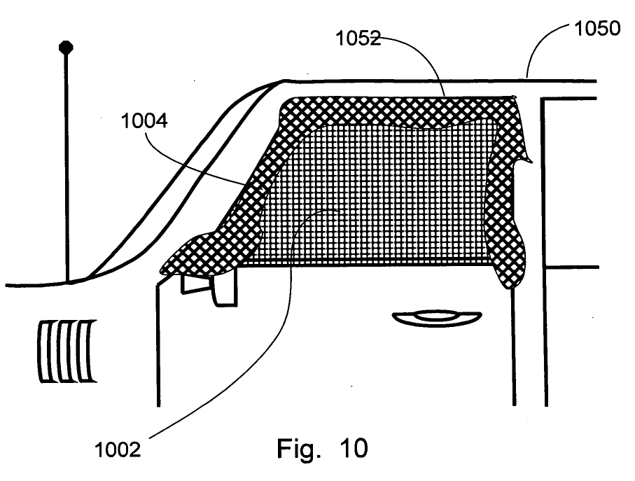

The length is particularly important in regard to employment of the invention, so the structures relating to that length will now be spelled out. In particular, the dimension of the mosquito net should exceed the dimension of the window by an “overlap” distance on each side. As a result, if a typical vehicle window has a dimension “L”, and the overlap distance desired on each edge is “O”, then a desirable dimension for the matching portion of the mosquito netting would be “L+2O”, that is, the window length plus the overlap on each side. The overlap distance in turn should be approximately equal to the distance of cloth necessary to traverse a typical vehicle window frame to the edge of the vehicle door, pass around the window frame and have a small excess present on the other side of the vehicle door. The reason for this particular degree of excess will be clarified in relation to FIGS. 7 and 10.

Polymer tubing 112 should be a soft and flexible type of tubing such as rubber or rubbery polymers. Residential building “window stripping” has been tested in the application and found to work well, and other soft, pliable types of tubing or the like may also be used. The tubing should have a diameter approximately equivalent to that of a vehicle window channel, the vehicle window channel being defined for purposes of this application as the small crack down which a vehicle window vanishes as it is rolled down. The polymer tubing 112 should be of a diameter roughly equivalent to this channel so that when the window is rolled down, the tubing may be inserted along the length of the channel and will be retained therein.

In the presently preferred embodiment, the tubing is required only along the bottom edge 110, but such tubing may in alternative embodiments extend up and along some or all of the other edges of the invention, allowing the insertion of the tubing into the “channels” which hold the window edges when it is in a rolled up position.

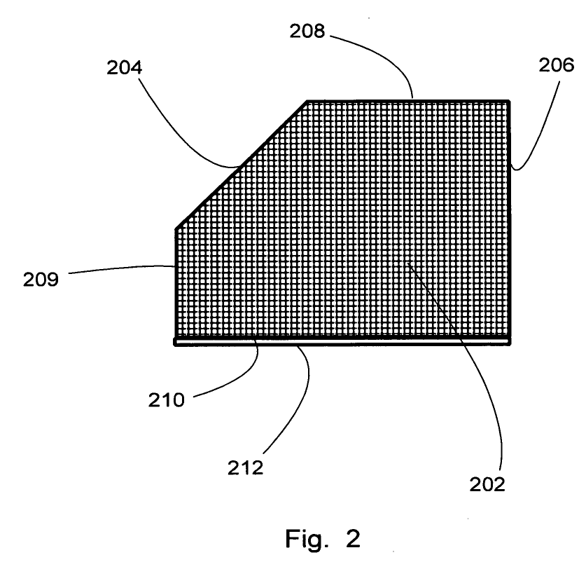

FIG. 2 is a planform side view of a second embodiment of the invention having “crunch tube” type deformable plastic tubing across the bottom edge. Mosquito net 202 has a somewhat different irregular shape, having five sides, as certain vehicles have windows which are not four sided. It will be appreciated that numerous irregular shapes of windows exist and that the invention may be dimensioned and configured to a wide range of window shapes. In this irregular shape, the netting has first side 204, second side 206, third side 208, additional side 209, bottom (fifth) side 210 and so on.

In this case, the polymer tubing at the bottom side 210 is actually a plastic polymer tubing 212 which has the ability to “crunch” into a new shape. (For purposes of the present application, the term “crunch” is defined as being the ability to deform by creasing but retain at least limited ability to return to an earlier shape. The most common example of “crunch” tubing is the common soda straw, and while straws have not yet been tested in use, it is believed that soda straws and soda straw materials would function well in the alternative disposable embodiments.)

Plastic tubing 212 may function as previously noted: it may be used along the bottom side 210 or it may extend along other sides as well, and it is dimensioned and configured to be pushed into and retained inside vehicle window channels.

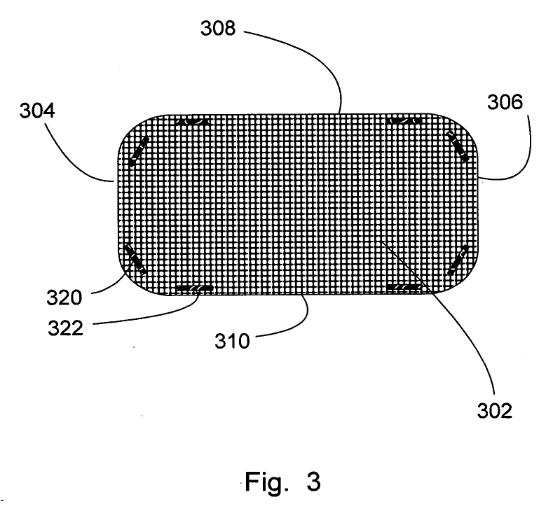

FIG. 3 is a planform side view of a third embodiment of the invention having hook-and-loop fabric fasteners disposed about the periphery. Not all vehicle windows are suitable for the intended best mode now contemplated and the use thereof (discussed in reference to FIGS. 7 and 10). For example, “sun roofs” and “moon roofs” usually do not have a peripheral door frame and thus the embodiments previously discussed would not work as intended. For such uses, the alternative embodiment of FIG. 3 is useful. Mosquito net 302 is not dimensioned and configured for draping over vehicle doors and thus does not have the length+double overlap dimensions discussed previously. Instead, first side 304, second side 306, third side 308 and fourth side 310 all have patches of hook-and-loop fabric 320, 322, etc affixed thereto.

None of the reference patents found to date have hook-and-loop fabric (such as VELCRO® brand hook-and-loop fabric), furthermore all teach alternative structures such as magnets and thus teach away from the use of hook-and-loop fabric for vehicle window mosquito nets.

The device of the alternative embodiment may thus be fastened to fabric vehicle interiors. This is particularly effective for sun roofs, moon roofs and the like, as most vehicles have fabric roofs which accept hook-and-loop fabric quite effectively. The alternative employment may of course work on any other embodiment too, such as may be dimensioned and configured for use with a vehicle door.

Finally, all embodiments of the device may be equipped with hook-and-loop fabric patches (one or more) for storage, not for use. It will be appreciated that when the embodiment of FIG. 3 is folded or rolled, the hook-and-loop fabric patches may be used to “self store” the device: the patches may be adhered to other parts of the device in order to retain it in the rolled/folded/stuffed/crumpled position of storage without the need for extending ties or pouches as shown in other diagrams.

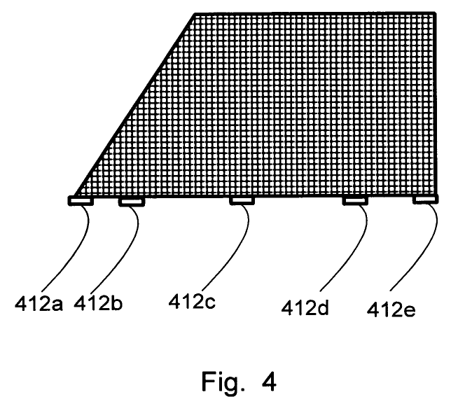

FIG. 4 is a planform side view of a fourth embodiment of the invention having a series of shorter flexible or crunch style polymer/plastic tubes across the bottom edge. Instead of a continuous single section of polymer tubing, multiple tubing sections 412a, 412b, 412c, 412d, 412e are provided. In embodiments using expensive forms of tubing fasteners, this may reduce manufacturing costs, while in all embodiments this will dramatically ease folding of the device when not in use.

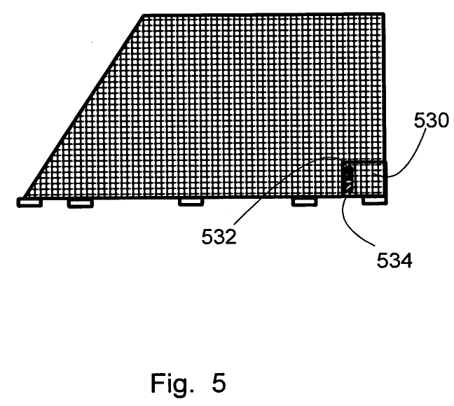

When not in the unfolded position of use, various structures may be employed to provide the device with a convenient folded position of storage. FIG. 5 is a planform side view of a fifth embodiment of the invention having a built-in pocket for containerizing the device when not in use. (Note that FIG. 5 is shown in a planform view similar to the position of use.)

Pocket 530 may be disposed at any location on the mosquito netting, may overlap portions of the body or may extend from one side, that is, the pocket 530 may be an extension of the body or may be integral with it. Flap 532 may cover an opening thereunder, while hook-and-fabric 534 may advantageously be employed to hold the flap 532 closed.

For purposes of this application, the term “folded” includes rolling up a net, crumpling it up, stuffing it into a small container, combinations thereof and similar structures.

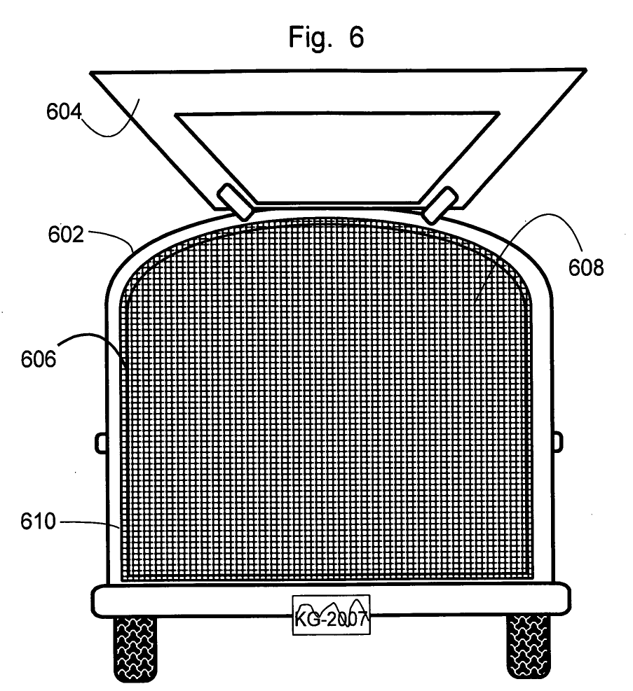

FIG. 6 is a rear planform view of a sixth embodiment of the invention having an elastic peripheral member and a larger size suitable for hatchback applications.

Vehicle rear end 602 may be a small car with a hatchback, a minivan, an SUV or similar vehicle, a station wagon, a cross-species type vehicle similar to any of these types, a full sized van, a panel van, work vehicles having rear hatch equipment and so on.

Hatch 604 may have a hatchway edge 606, normally a rubber seal or metal baffle or combination thereof which may extend around the entire periphery or substantially the entire periphery of the hatch. Mosquito net 608 may be affixed thereto by means of elastic 610 which may also extend around the periphery of the mosquito net 608 and may urge the netting against the outside of the hatchway edge 606. By this means, the vehicle rear may be used in an open position in areas having mosquitoes and other noxious insect life.

FIG. 7 is a side planform view of an embodiment of the invention in use draped over the outside of a vehicle door. It may be seen in FIG. 7 that mosquito net 702 has front edge 704 passing about the front edge of the vehicle door 752 and is thus clamped between the vehicle door 752 and the vehicle body 750, with a portion of excess hanging inside of the vehicle interior (not visible). Rear edge 706 is similarly clamped between the rear edge of door 752 and vehicle 750, as are most other edges, for example, top edge 708.

Bottom edge 710 on the other hand, may not be so conveniently disposed for the majority of vehicles, which tend to have windows which don't open at the bottom edge. Vehicle door 752 however has window edge/channel/track 754, (the window track or channel is hereby defined as that small gap into which the window retreats as it is rolled down), into which track polymer tubing as depicted in FIGS. 1, 2, 4 and 5 may be inserted when the window is rolled down and the gap is no longer occupied by the window. Note that in most cases, the polymer tubing may even be inserted into the flexible strips of the track even when the window is wholly or partially rolled up.

FIG. 10 is a side planform view of an embodiment of the invention in use draped over the inside of a vehicle door. Vehicle 1050 has vehicle door 1052 with the mosquito netting spread across the window space on the inside of the door 1052, not the outside.

This diagram shows the overlap (dimension “O”) of each side very clearly. Mosquito net 1002 may be seen to have hanging excess 1004, which represents the difference between the approximate length “L” of the vehicle window and the full length of the embodiments having a length of “L plus two times O”. Note that on the top to bottom dimension, the length (height) of the invention may merely be “L+O”, that is, there is only overlap/excess provided on the top edge, and not on the bottom edge.

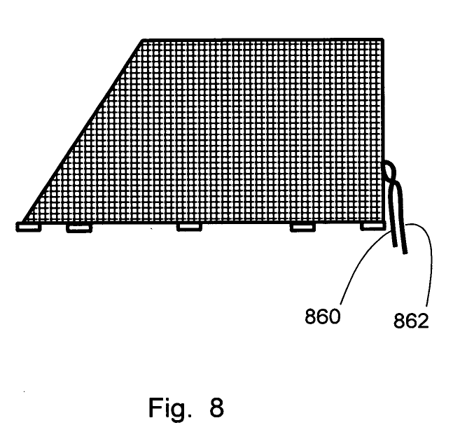

FIG. 8 is a side planform view of a seventh embodiment of the invention having ties used to secure the device when rolled/folded. First tie 860 and second tie 862 may be seen to extend from the edge/periphery of the device, however, they may be disposed at a location other than the periphery. The ties may be dimensioned to extend about the entire device when it is folded/rolled/stuffed into a more compact position for storage, and the ties may be equipped with hook-and-loop fabric, snaps, buttons, etc. The ties may take the form of a flaps, tabs, tongues, collars or the like. A single tie may be used, or multiple ties may be used.

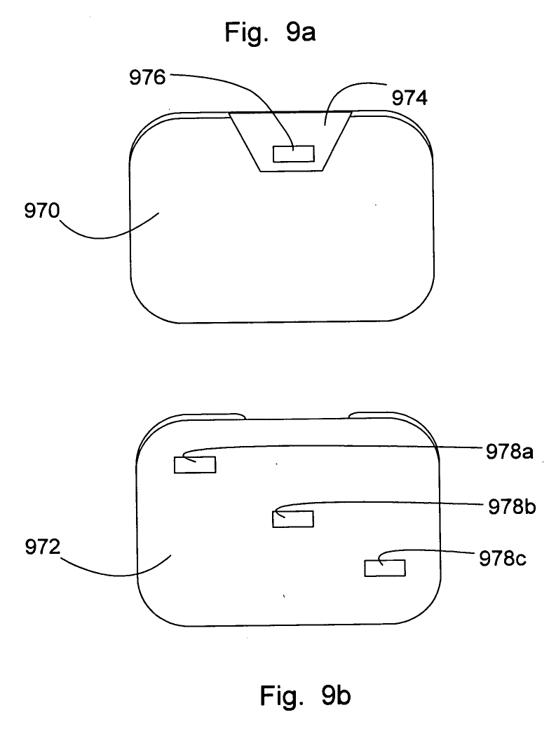

FIG. 9a is a view of one side of a pouch of an eighth embodiment, the pouch used for holding the invention when not in use. FIG. 9b is a view of one side of a pouch for holding the eighth embodiment of the invention when not in use.

First side of pouch 970 and second side of pouch 972 have a tie in the form of closure flap 974 equipped with hook-and-loop fabric 976. Additional patches of hook-and-loop fabric 978a, 978b, 978c may be provided on the sides of the pouch body.

In the presently preferred embodiment and best mode presently contemplated for carrying out the invention, a coating of pyrethroid insecticide may be applied to the mosquito netting. Only in recent years has it been discovered that such insecticides dramatically increase the effectiveness of mosquito netting, and the pyrethroid insecticides have a high degree of persistence, often lasting for months or years. Other chemicals may be applied as well, for example, DEET is known to disorient hunting mosquitoes and cause them to fly in random directions rather than towards the strongest local smell.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A vehicle accessory comprising:
a mosquito net dimensioned and configured to cover a vehicle window and having at least one edge;
a first flexible polymer tube secured to the at least one edge.

2. The vehicle accessory of claim 1, further comprising:
a second flexible polymer tube secured to the at least one edge.

3. The vehicle accessory of claim 1, wherein the first flexible polymer tube further comprises:
a deformable plastic.

4. The vehicle accessory of claim 1, further comprising:
a pocket attached to the vehicle accessory, the pocket dimensioned and configured to accept the mosquito net and first flexible polymer tube when the mosquito net and first flexible polymer tube are disposed in a folded position.

5. The vehicle accessory of claim 1, further comprising:
at least one tie attached to the vehicle accessory, the tie long enough to encompass the mosquito net and first flexible polymer tube when the mosquito net and first flexible polymer tube are disposed in a folded position.

6. The vehicle accessory of claim 1, further comprising:
a coating of pyrethroid insecticide.

7. A vehicle accessory comprising:
a mosquito net dimensioned and configured to cover a vehicle window and having at least one edge;
a first hook-and-loop fabric panel secured to the at least one edge.

8. The vehicle accessory of claim 7, further comprising:
a second hook-and-loop fabric panel secured to the at least one edge at a location distal the first hook-and-loop fabric panel.

9. The vehicle accessory of claim 7, further comprising:
at least one tie attached the vehicle accessory, the tie long enough to encompass the mosquito net and first flexible polymer tube when the mosquito net and first flexible polymer tube are disposed in a folded position.

10. The vehicle accessory of claim 7, further comprising:
a coating of pyrethroid insecticide.

11. The vehicle accessory of claim 7, further comprising:
a pocket attached to the vehicle accessory, the pocket dimensioned and configured to accept the mosquito net and first flexible polymer tube when the mosquito net and first flexible polymer tube are disposed in a folded position.

12. A vehicle accessory comprising:
a mosquito net dimensioned and configured to cover a vehicle rear hatch perimeter and having at least one edge;
an elastic member having a length, the length sufficient to allow the elastic member, when distended, to pass around the vehicle rear hatch perimeter.

13. The vehicle accessory of claim 12, wherein the elastic member is further firmly secured to the at least one edge of the mosquito net.
